(19) United States
(12) Patent Application Publication
(10) Pub. No.: US 2023/0184648 A1
(43) Pub. Date: Jun. 15, 2023

(54) METHOD FOR PREDICTING CREEP DAMAGE AND DEFORMATION EVOLUTION BEHAVIOR WITH TIME

(71) Applicant: NANJING UNIVERSITY OF AERONAUTICS AND ASTRONAUTICS, Nanjing (CN)

(72) Inventors: Yingdong SONG, Nanjing (CN); Xu ZHAO, Nanjing (CN); Zhigang SUN, Nanjing (CN); Xuming NIU, Nanjing (CN)

(21) Appl. No.: 18/094,659

(22) Filed: Jan. 9, 2023

Related U.S. Application Data
(63) Continuation of application No. PCT/CN2021/141551, filed on Dec. 27, 2021.

(30) Foreign Application Priority Data
Dec. 14, 2021 (CN) 202111526072.6

(51) Int. Cl. G01N 3/08; G01N 3/02

(52) U.S. Cl. CPC G01N 3/08; G01N 3/02; G01N 2203/0071; G01N 2203/0226; G01N 2203/0218; G01N 2203/0017

(57) ABSTRACT

Disclosed is a method for predicting creep damage and deformation evolution behavior with time, which comprises the following steps: obtaining tensile strength σ_{b} through high-temperature tensile test; obtaining the strain curve, minimum creep rate \dot{ε}ₘ and life t_{ƒ} through creep test; obtaining the threshold stress σₜₕ at different temperatures; establishing the relationship between the tensile strength σ_{b}, the threshold stress σₜₕ and the temperature T; establishing the prediction formulas of the minimum creep rate σₜₕ and creep life σ_{b} based on the threshold stress \dot{ε}ₘ and the tensile strength t_{ƒ}; establishing a creep damage constitutive model, including strain rate formula and damage rate formula; obtaining the evolution behavior of strain and deformation with time; obtaining the evolution behavior of damage with time.

### CROSS-REFERENCE TO RELATED APPLICATIONS

This application is a continuation of PCT/CN2021/141551, filed on Dec. 27, 2021 and claims priority of Chinese Patent Application No. 202111526072.6, filed on Dec. 14, 2021, the entire contents of which are incorporated herein by reference.

### TECHNICAL FIELD

The application relates to a method for predicting creep damage and deformation evolution behavior with time, and in particular to a method for predicting creep damage and deformation evolution behavior with time by using a creep damage constitutive model.

### BACKGROUND

When working under high temperature environment for a long time, high-temperature components are prone to creep deformation, accompanied by creep damage. Creep damage includes voids, cracks, coarsening of precipitates, phase transformation of strengthening phase, oxidation and corrosion. However, due to the complexity and variety of creep damage forms, it is difficult to quantify the creep damage, characterize the damage in the process of creep continuously, and describe the evolution behavior of creep deformation with time. In addition, the existing creep models often describe a single curve, and the fitting parameters have a strong stress-temperature correlation, which is not clearly defined, so it is difficult to achieve reliable extrapolation. Therefore, it is necessary to develop a prediction method to predict the creep deformation and the damage evolution behavior in the process of deformation, so as to quantitatively evaluate the damage of high-temperature components.

### SUMMARY

The objective of the application is to provide a method for predicting creep damage and deformation evolution behavior with time, so as to realize quantitative evaluation of damage of high-temperature components.

To achieve the above objective, the application adopts the following technical scheme.

S1, carrying out high-temperature tensile tests of materials at different temperatures T to obtain tensile strength σ_{b} at different temperatures;

S2, carrying out high-temperature creep tests under different stress conditions at different temperatures to obtain corresponding creep strain curves, a minimum creep rate \dot{ε}ₘ and a creep life t_{θ};

S3, obtaining threshold stresses σₜₕ corresponding to different temperatures according to the minimum creep rate \dot{ε}ₘ obtained in the S2;

S4, establishing a functional relationship between the tensile strength σ_{b}, the threshold stress σₜₕ and the temperature T according to the tensile strength σ_{b} at different temperatures obtained in the S1 and the threshold stresses σₜₕ at different temperatures obtained in the S3;

S5, on the basis of the threshold stress σₜₕ obtained in the S3 and the tensile strength σ_{b} obtained in the S1, establishing prediction formulas of the minimum creep rate \dot{ε}ₘ and the creep life t_{ƒ} based on the threshold stress σₜₕ and the tensile strength σ_{b}, respectively, and the minimum creep rate \dot{ε}ₘ and the creep life t_{ƒ} under any stress temperature condition are predicted by the prediction formulas;

S6, establishing a creep damage constitutive model based on the prediction formulas of the minimum creep rate \dot{ε}ₘ and the creep life t_{ƒ} established in the S5, wherein the creep damage constitutive model includes a strain rate formula and a damage rate formula;

Step 7, determining parameters in the creep damage constitutive model established in the S6; and

S8, obtaining an evolution behavior of strain deformation with time by solving the strain rate formula; and obtaining an evolution behavior of damage with time by solving the damage rate formula.

In the S3, a relationship between the minimum creep rate \dot{ε}ₘ, the stress σ and the threshold stress σₜₕ at a σ_{b} same temperature is established by using the formula \dot{ε}ₘ=Aₘ(σ−σₜₕ)⁵ according to the minimum creep rate \dot{ε}ₘ data obtained from the high-temperature creep tests in the S2, where Aₘ is a constant; doing a same operation for different temperatures, and then obtaining threshold stress levels corresponding to different temperatures.

In the S4, a functional relationship between the tensile strength σ_{b}, the threshold stress σₜₕ and the temperature T is established according to the tensile strength σ_{b} at different temperatures obtained in the S1 and the threshold stresses σₜₕ at different temperatures obtained in the S3, a polynomial is used for fitting,

$${σ}_{b} = {\sum }_{i = 0}^{n} {{a}_{i} ( T )}^{i} , {σ}_{th} = {\sum }_{i = 0}^{n} {b}_{i} ( {T}^{i} ) ,$$

where n is a number of polynomial terms and aᵢ, bᵢ are fitting parameters, i=0,1,2 . . . ,n, ^{n≤3}.

In the S5, on the basis of the threshold stress σₜₕ obtained in the S3 and the tensile strength σ_{b} obtained in the S1, the prediction formulas of the minimum creep rate \dot{ε}ₘ and the creep life t_{ƒ} based on the threshold stress σₜₕ and the tensile strength σ_{b} are respectively established:

$${\dot{ε}}_{m} = {( \frac{1}{{A}_{1}} \frac{σ - {σ}_{th}}{{σ}_{b} - σ} )}^{1 / {n}_{1}} exp ( - {Q}_{N}^{*} / RT ) \\ {t}_{f} = {( \frac{1}{{A}_{2}} \frac{σ - {σ}_{th}}{{σ}_{b} - σ} )}^{1 / {n}_{2}} exp ( - {Q}_{N}^{*} / RT ) ,$$

where A₁, A₂, n₁ and n₂ are constants, σₜₕ is the threshold stress, σ_{b} is the tensile strength, σ is applied stress, T is applied temperature, R is a gas constant(R=8.314J/(mo [symbol] )), and Q*_{N} is apparent activation energy;

The minimum creep rate \dot{ε}ₘ and creep life t_{ƒ} may be predicted by the above two expressions under arbitrary stress temperature conditions.

In the S5, the apparent activation energy Q*_{N} is obtained by the following method: under a same

$$\frac{σ - {σ}_{th}}{{σ}_{b} - σ}$$

value, the apparent activation energy Q*_{N} is determined by a linear fitting straight line slope between a logarithm 1n \dot{ε}ₘ of the minimum creep rate and the reciprocal 1/T of the temperature.

In the S6, establishing a creep damage constitutive model based on the prediction formulas of the minimum creep rate \dot{ε}ₘ and the creep life t_{ƒ} in the S5:

$$\dot{ε} = {( \frac{1}{{A}_{1}} \frac{σ - {σ}_{th}}{{σ}_{b} - σ} )}^{1 / {n}_{1}} exp ( - {Q}_{N}^{*} / RT ) exp ( {λω}^{3 / 2} ) \\ \dot{ω} = {( \frac{1 - {e}^{- q}}{q} ) [ ( {( \frac{1}{{A}_{2}} \frac{σ - {σ}_{th}}{{σ}_{b} - σ} )}^{1 / {n}_{2}} exp ( - {Q}_{N}^{*} / RT ) ]}^{- 1} exp ( q ω ) ,$$

where \dot{ε} is the strain rate, \dot{ω} is the damage rate, ε is the strain and ω is the damage, q is a constant related to the temperature, λ is a constant related to the temperature and the stress; in order to ensure that when creep fracture occurs, the damage is 1, λ is defined as a logarithm of the creep rate \dot{ε}_{final} to the minimum creep rate \dot{ε}ₘ when creep fracture occurs, λ=1n(\dot{ε}_{final}/\dot{ε}ₘ); fitting the experimental data, and the expression of λ is established as λ=(α₁T+α₂)σ+(α₃T+α₄), wherein α₁, α₂, α₃ and α₄ are the fitting parameters.

In the S7, the damage rate formula in step 6 is integrated, obtaining:

$$ω = - \frac{1}{q} ln [ 1 - ( 1 - {e}^{- q} ) \frac{t}{{t}_{f}} ] ,$$

where

$${t}_{f} = {( \frac{1}{{A}_{2}} \frac{σ - {σ}_{th}}{{σ}_{b} - σ} )}^{1 / {n}_{2}} exp ( {Q}_{N}^{*} / RT ) ,$$

the above-mentioned damage w obtained by an integral is called an analytical damage;

mathematically transform the strain rate formula in the S6 as follows:

$$ω = {[ \frac{1}{λ} ln ( \dot{ε} / {\dot{ε}}_{m} ) ]}^{2 / 3} ,$$

where

$${\dot{ε}}_{m} = {( \frac{1}{{A}_{1}} \frac{σ - {σ}_{th}}{{σ}_{b} - σ} )}^{1 / {n}_{1}} exp ( - {Q}_{N}^{*} / RT ) ,$$

the damage ω is called a test damage;

a numerical optimization algorithm is used to carry out a least square optimization on the analytical damage and the test damage, and the corresponding constant q value is obtained.

In the S8, a fourth-order Runge-Kutta method is adopted to solve the strain rate formula to obtain an evolution behavior of strain and deformation with time; for the damage rate formula, a damage evolution behavior with time is obtained by using the formula

$$ω = - \frac{1}{q} ln [ 1 - ( 1 - {e}^{- q} ) \frac{t}{{t}_{f}} ] .$$

Compared with the prior art, the technical scheme has the following technical effects.

Firstly, the method for predicting creep damage and deformation evolution behavior with time provided by the application may accurately predict the minimum creep rate and creep life only by performing high-temperature tensile tests and high-temperature creep tests, and has the advantages of few required parameters, simple test, low cost and high precision;

Secondly, the method for predicting creep damage and deformation evolution behavior with time provided by the application is based on the continuous damage mechanics framework, and may continuously predict the creep damage and deformation evolution with time, quantify the creep damage, and when the creep time is 0, the damage is 0, and when the creep time reaches the creep life, the damage is 1;

Thirdly, the method for predicting creep damage and deformation evolution behavior with time provided by the application takes into account the uncertainty of creep data, which comes from many factors, including material dispersion, sample surface roughness, test deviation. Therefore, this method pays more attention to the average creep behavior under specific creep conditions, which represents the mid-value under this condition, rather than the single creep curve behavior. Moreover, all the parameters in this method have clear stress-temperature correlation, which makes this method have stronger interpolation and extrapolation capabilities; and

Fourthly, the method for predicting creep damage and deformation evolution behavior with time provided by the application may be applied to alloy and other materials widely used in engineering, and has good applicability.

### BRIEF DESCRIPTION OF THE DRAWINGS

FIG. 1 is a diagram of threshold stress calculation method.

FIG. 2 is the reciprocal relationship between logarithmic minimum creep rate and temperature.

FIG. 3 is a diagram of linear fitting test data to solve (a) constants n₁ and A₁ and (b) constants n₂ and A₂.

FIG. 4 is a graph showing the relationship between λ and stress and temperature.

FIG. 5(A)-FIG. 5(B) is the evolution behavior of creep (a) strain and (b) damage with time at 600° C.

FIG. 6(A)-FIG. 6(B) is the evolution behavior of creep (a) strain and (b) damage with time at 650° C.

### DETAILED DESCRIPTION OF THE EMBODIMENTS

The technical scheme of the present application will be further explained in detail with reference to the accompanying drawings.

The application discloses a method for predicting creep damage and deformation evolution behavior with time, including:

S1, firstly, carrying out high-temperature tensile tests of materials at different temperatures T to obtain the tensile strength σ_{b} at corresponding temperatures;

S2, carrying out multiple groups of high-temperature creep tests under different stress conditions at different temperatures to obtain corresponding creep strain curves, minimum creep rate \dot{ε}ₘ and creep life t_{ƒ};

S3, establishing the relationship between the minimum creep rate \dot{ε}ₘ, the stress σ and the threshold σₜₕ stress at the same temperature by using the formula \dot{ε}ₘ=Aₘ(σ−σₜₕ)⁵ according to the minimum creep rate \dot{ε}ₘ data obtained from the high-temperature creep test, where Aₘ is a constant; taking both sides of formula \dot{ε}ₘ=Aₘ(σ−σₜₕ)⁵ to the power of ⅕ at the same time, and obtaining (\dot{ε}ₘ)^{1/5}=Aₘ^{1/5} (σ−σₜₕ), where (\dot{ε}ₘ)^{1/5} is the ordinate and σ is the abscissa, the test data at the same temperature are linearly fitted, and the intercept between the fitted straight line and the X axis is the threshold stress σₜₕ at this temperature; carrying out the same operation for different temperatures, and then get the threshold stress σₜₕ corresponding to different temperatures;

S4, according to the corresponding tensile strength and threshold stress values at different temperatures obtained in S1 and S3, carrying out fitting by using polynomials, so as to establish the functional relationship between the tensile strength σ_{b} and the threshold stress σₜₕ and the temperature

$$T , {σ}_{b} = {\sum }_{i = 0}^{n} {a}_{i} ( {T}^{i} ) , {σ}_{th} = {\sum }_{i = 0}^{n} {b}_{i} ( {T}^{i} ) ,$$

where n is the number of polynomial terms, aᵢ and bᵢ are fitting parameters, and i=0,1,2, . . . , n, n≤3.

S5, establishing the minimum creep rate \dot{ε}ₘ and the creep life t_{ƒ} prediction formulas based on the threshold stress and the tensile strength respectively based on the threshold stress σₜₕ and the tensile strength σ_{b} at a specific temperature obtained in the above steps

$${\dot{ε}}_{m} = {( \frac{1}{{A}_{1}} \frac{σ - {σ}_{th}}{{σ}_{b} - σ} )}^{1 / {n}_{1}} exp ( - {Q}_{N}^{*} / RT ) \\ {t}_{f} = {( \frac{1}{{A}_{2}} \frac{σ - {σ}_{th}}{{σ}_{b} - σ} )}^{1 / {n}_{2}} exp ( {Q}_{N}^{*} / RT ) ,$$

where A₁, A₂, n₁ and n₂ are constants, which may be obtained by linear fitting. σₜₕ is the threshold stress, σ_{b} is the tensile strength, σ is the stress, T is the temperature, and the unit is Kelvin temperature K, R is the gas constant (R=8.314J/(mol□K)). Q*_{N} is the apparent activation energy, which may be determined by the relationship between the logarithm of the minimum creep rate and the reciprocal of the temperature under the same

$$\frac{σ - {σ}_{th}}{{σ}_{b} - σ}$$

value. The specific method is as follows: when the

$$\frac{σ - {σ}_{th}}{{σ}_{b} - σ}$$

values are the same, with \dot{ε}ₘ as the ordinate and the reciprocal 1/T of temperature as the abscissa, the experimental data are linearly fitted, and the slope of the fitted straight line is

$$- \frac{{Q}_{N}^{*}}{R} ,$$

and then the apparent activation energy Q*_{N} value is obtained.

The prediction formulas of minimum creep rate \dot{ε}ₘ and creep life t_{ƒ} are mathematically transformed, and the logarithm of both sides of the equation is obtained.

$$ln [ {\dot{ε}}_{m} exp ( {Q}_{N}^{*} / RT ) ] = \frac{1}{{n}_{1}} ln ( \frac{σ - {σ}_{th}}{{σ}_{b} - σ} ) + \frac{1}{{n}_{1}} ln ( \frac{1}{{A}_{1}} ) \\ ln [ {t}_{f} exp ( - {Q}_{N}^{*} / RT ) ] = \frac{1}{{n}_{2}} ln ( \frac{σ - {σ}_{th}}{{σ}_{b} - σ} ) + \frac{1}{{n}_{2}} ln ( \frac{1}{{A}_{2}} ) ,$$

constants A₁ and n₁ may be obtained by the slope and intercept of the best linear fitting line of

$$ln [ {\dot{ε}}_{m} exp ( {Q}_{N}^{*} / RT ) ] - ln ( \frac{σ - {σ}_{th}}{{σ}_{b} - σ} )$$

test data, respectively. Likewise constants A₂ and n₂ may be obtained by the slope and intercept of the best linear fitting straight line of

$$ln [ {t}_{f} exp ( - {Q}_{N}^{*} / RT ) ] - ln ( \frac{σ - {σ}_{th}}{{σ}_{b} - σ} )$$

test data, respectively.

In this way, the minimum creep rate \dot{ε}ₘ and the creep life t_{ƒ} at any stress temperature may be accurately predicted by the above minimum creep rate \dot{ε}ₘ and the creep life t_{ƒ} prediction formulas. At a certain temperature, when the stress approaches the threshold stress σₜₕ, the minimum creep rate \dot{ε}ₘ tends to zero and the creep life tends to infinity; when the stress approaches the tensile strength σ_{b}, the minimum creep rate \dot{ε}ₘ tends to infinity and the creep life tends to zero.

S6, establishing a creep damage constitutive model based on the minimum creep rate \dot{ε}ₘ and creep life t_{ƒ} prediction formulas established in the S5:

$$\dot{ε} = {( \frac{1}{{A}_{1}} \frac{σ - {σ}_{th}}{{σ}_{b} - σ} )}^{1 / {n}_{1}} exp ( - {Q}_{N}^{*} / RT ) exp ( {λω}^{3 / 2} ) \\ \dot{ω} = {( \frac{1 - {e}^{q}}{q} ) [ {( \frac{1}{{A}_{2}} \frac{σ - {σ}_{th}}{{σ}_{b} - σ} )}^{1 / {n}_{1}} exp ( {Q}_{N}^{*} / RT ) ]}^{- 1} exp ( q ω ) ,$$

where \dot{ε} is the strain rate, \dot{ω} is the damage rate, ε is the strain, ω is the damage, q is the constant related to temperature, and λ is the constant related to temperature and stress. To ensure that when the creep time reaches the creep life, when the creep fracture occurs, the damage is 1, and λ is defined as the logarithm of the ratio of the creep rate to the minimum creep rate at fracture, λ=1n((\dot{ε}_{final}/\dot{ε}ₘ). Using the λ value obtained from the high-temperature creep test carried out in the S2, the dependence relationship between λ value and temperature stress may be established by linear fitting method, λ=(α₁T+α₂)σ+(α₃T+α₄), constants α₁, α₂, α₃ and α₄ may be obtained by fitting the test data of λ with stress and temperature.

S7, integrating the damage rate formula in the S6,

$$ω = - \frac{1}{q} ln [ 1 - ( 1 - {e}^{- q} ) \frac{t}{{t}_{f}} ] ,$$

where

$${t}_{f} = {( \frac{1}{{A}_{2}} \frac{σ - {σ}_{th}}{{σ}_{b} - σ} )}^{1 / {n}_{2}} exp ( {Q}_{N}^{*} / RT ) .$$

The above-mentioned damage ω obtained by integration is called analytical damage.

Mathematically transform the strain rate formula in step 6 as follows:

$$ω = {[ \frac{1}{λ} ln ( \dot{ε} / {\dot{ε}}_{m} ) ]}^{2 / 3} ,$$

where

$${\dot{ε}}_{m} = {( \frac{1}{{A}_{1}} \frac{σ - {σ}_{th}}{{σ}_{b} - σ} )}^{1 / {n}_{1}} exp ( - {Q}_{N}^{*} / RT ) ,$$

this damage ω is called test damage.

At the same temperature, a numerical optimization algorithm is used to carry out a least square optimization on the analytical damage and the test damage, and the corresponding constant q value is obtained. Then, the functional relationship between the constant q value and the temperature may be established by linearly fitting the temperature and the constant q value, and the constant b₁ number and the constant b₂ value in q=b₁T+b₂ may be obtained. Through the above S5-7, all the parameters in the creep damage constitutive model are uniquely determined.

S8, after all the parameters in the damage constitutive model are determined by the above steps, the fourth-order Runge-Kutta method is adopted to solve the strain, and the evolution behavior of strain and deformation with time may be obtained. Specifically, the analytical damage ω obtained by integration is brought into the strain rate formula, and the creep rate \dot{ε}ₘ corresponding to any moment tₙ may be obtained. For the strain εₙ of at any time tₙ, the fourth-order Runge-Kutta algorithm may be used to calculate the strain increment of each adjacent time interval, and the strain εₙ may be solved by the method of accumulation,

$${ε}_{n} = {ε}_{0} + \frac{1}{6} {\sum }_{i = 1}^{n} \{ [ \dot{ε} ( {t}_{i - 1} ) + \dot{ε} ( {t}_{i} ) + 4 \dot{ε} ( \frac{{t}_{i - 1} + {t}_{i}}{2} ) ] * ( {t}_{i} - {t}_{i - 1} ) \} ,$$

where ε₀=0=, t₀=0.

For the damage, the analytical damage formula

$$ω = - \frac{1}{q} ln [ 1 - ( 1 - {e}^{- q} ) \frac{t}{{t}_{f}} ]$$

may be used to obtain the evolution behavior of damage with time. When t=t_{ƒ}, the creep fracture occurs, the damage ω=1. In this way, the creep damage and deformation evolution with time may be described.

In the application, the high-temperature tensile test of the material aims at obtaining the corresponding tensile strength σ_{b} of the material at different temperatures T, and providing necessary parameter input for subsequent high-temperature creep test, minimum creep rate and creep life prediction method based on threshold stress and tensile strength, and determination of creep damage constitutive model.

High-temperature creep test of materials are as follows: creep tests under multiple groups of stresses are conducted at different temperatures, generally 2-4 temperature values may be selected, and 5-7 groups of high-temperature creep tests under different stresses may be conducted at each temperature value. Until the creep fracture of the material occurs, the corresponding creep strain curves, minimum creep rate \dot{ε}ₘ and creep life t_{ƒ} under different stress and temperature conditions are obtained.

The test instruments adopted by the application include an electro-hydraulic servo fatigue tester and a creep tester.

The application will be further explained with reference to the following specific embodiments.

### Embodiment

In this embodiment, the method for predicting creep damage and deformation evolution behavior with time of the present application is applied to the prediction of creep damage and deformation of nickel-base superalloy GH4169, including the following steps.

(1) The high-temperature tensile test of GH4169 material is carried out at 600° C. and 650° C., and the corresponding tensile strength is 1440 MPa and 1255 MPa, respectively.

(2) The high-temperature creep tests of GH4169 material with six different stress values are carried out at 600° C. and 650° C. respectively, and the corresponding creep strain curves, minimum creep rate \dot{ε}ₘ and creep life t_{ƒ} are obtained. The specific test scheme and the obtained test data are shown in Table 1.

TABLE 1
creep test scheme and data of gh4169 material

| | | | Minimum | Creep |
|---|---|---|---|---|
| | Temperature | Stress | creep | life |
| No. | (° C.) | (MPa) | rate(/h) | (h) |
| 1 | 600 | 925 | 0.000123 | 92.23 |
| 2 | | 880 | 0.000032 | 246 |
| 3 | | 850 | 0.000022 | 326 |
| 4 | | 820 | 0.000016 | 416.33 |
| 5 | | 805 | 0.000014 | 478 |
| 6 | | 790 | 0.0000066 | 905 |
| 7 | 650 | 820 | 0.00059 | 17 |
| 8 | | 770 | 0.00013 | 72 |
| 9 | | 720 | 0.00011 | 99 |
| 10 | | 670 | 0.00007 | 139 |
| 11 | | 615 | 0.000041 | 195 |
| 12 | | 595 | 0.000025 | 328.5 |

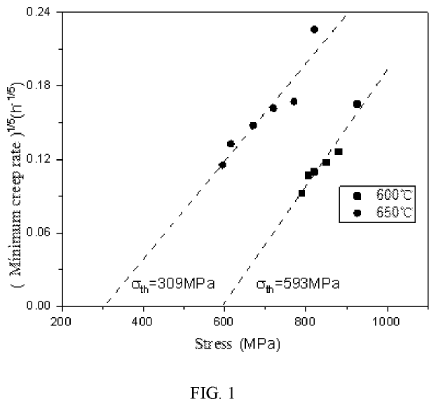

(3) Using the formula \dot{ε}ₘ=Aₘ(σ−σₜₕ)⁵, the (\dot{ε}ₘ)^{1/5}—σ data are linearly fitted at 600° C. and 650° C. respectively, and the stress value corresponding to the intersection of the fitted straight line and the X axis is the threshold stress at this temperature. The calculated threshold stress is shown in FIG. 1, and the threshold stress is 593 MPa at 600° C. and 309 MPa at 650° C. Using the threshold stresses at these two temperatures, the threshold stresses at other temperatures may be calculated by linear interpolation or extrapolation.

(4) Based on the above obtained tensile strength σ_{b} at 600° C. and 650° C. and threshold stress level σₜₕ, polynomial fitting may be used to establish the functional relationship between tensile strength and threshold stress and temperature respectively. Because the experiment only carried out two temperatures, the linear fitting method is adopted, and the first two terms in polynomial form are taken. The functional relations between tensile strength and threshold stress and temperature are obtained as follows: σ_{b}=−3.7*T+4670.1, σₜₕ=−5.68*T+5551.64 where T is Kelvin temperature.

(5) Based on the threshold stress σₜₕ and tensile strength σ_{b} at 600° C. and 650° C. obtained by the above steps, the minimum creep rate \dot{ε}ₘ and creep life t_{ƒ} prediction formulas based on the threshold stress and tensile strength are established respectively:

$${\dot{ε}}_{m} = {( \frac{1}{{A}_{1}} \frac{σ - {σ}_{t h}}{{σ}_{b} - σ} )}^{1 {/}_{{n}_{1}}} exp ( - {Q}_{N}^{*} / RT )$$

$${t}_{f} = {( \frac{1}{{A}_{2}} \frac{σ - {σ}_{t h}}{{σ}_{b} - σ} )}^{1 / {n}_{2}} exp ( {Q}_{N}^{*} / RT ) ,$$

firstly, under the same

$$\frac{σ - {σ}_{t h}}{{σ}_{b} - σ}$$

value, the Q*_{N} value of the apparent activation energy is determined by the linear fitting relationship between the logarithm of the minimum creep rate and the reciprocal of the temperature. Under the same

$$\frac{σ - {σ}_{t h}}{{σ}_{b} - σ}$$

value, the 1n

$${\dot{ε}}_{m} - \frac{1}{T}$$

test data is linearly fitted, and the slope is

$$- \frac{{Q}_{N}^{*}}{R} ,$$

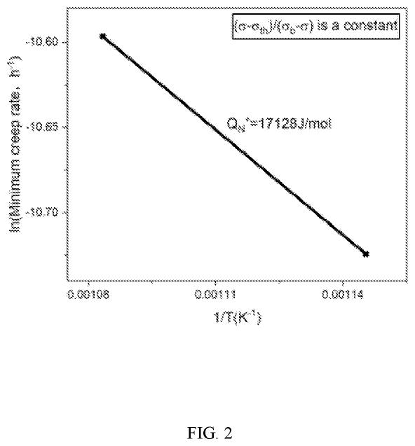

and then Q*_{N}=17128J/mol is obtained, as shown in FIG. 2.

Then, the minimum creep rate \dot{ε}ₘ and creep life t_{ƒ} prediction formulas are mathematically transformed, and the logarithm of both sides of the equation is taken at the same time to obtain:

$$ln [ {\dot{ε}}_{m} exp ( {Q}_{N}^{*} / RT ) ] = \frac{1}{{n}_{1}} ln ( \frac{σ - {σ}_{t h}}{{σ}_{b} - σ} ) + \frac{1}{{n}_{1}} ln ( \frac{1}{{A}_{1}} )$$

$$ln [ {t}_{f} exp ( - {Q}_{N}^{*} / RT ) ] = \frac{1}{{n}_{2}} ln ( \frac{σ - {σ}_{th}}{{σ}_{b} - σ} ) + \frac{1}{{n}_{2}} ln ( \frac{1}{{A}_{2}} ) ,$$

The unknown parameters A₁ and n₁ may be obtained by linearly fitting the experimental data of

$$ln [ {\dot{ε}}_{m} exp ( {Q}_{N}^{*} / RT ) ] - ln ( \frac{σ - {σ}_{th}}{{σ}_{b} - σ} ) ,$$

and The values of unknown parameters A₁ and nᵢ can be obtained by using the slope and intercept of the corresponding fitting line. Similarly, by linearly fitting

$$ln [ {t}_{f} exp ( - {Q}_{N}^{*} / RT ) ] - ln ( \frac{σ - {σ}_{th}}{{σ}_{b} - σ} )$$

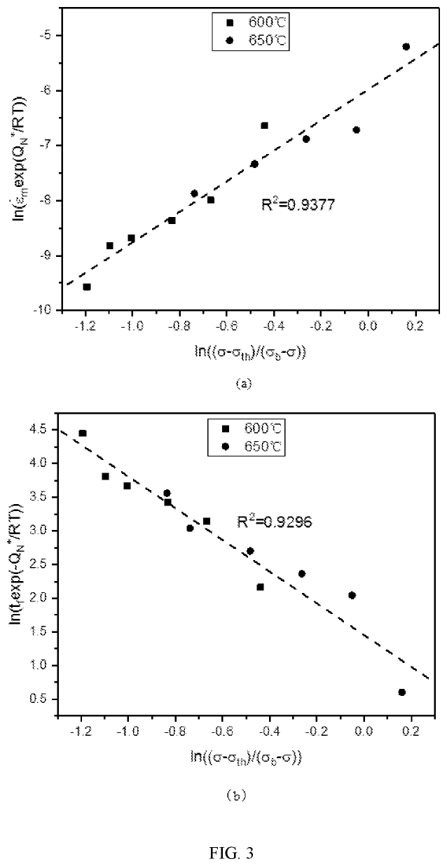

experimental data, the values of unknown parameters A₂ and n₂ may be obtained by using the slope and intercept of the corresponding fitting line. The fitted straight line is shown in FIG. 3, and the determination coefficients of the fitted straight line are 0.9377 and 0.9296 respectively, obtaining A₁=8.6249, n₁=0.3602, A₂=1.8529, n₂=−0.4244 by fitting. Therefore, the prediction formulas of minimum creep rate \dot{ε}ₘ and creep life t_{ƒ} are obtained:

$${\dot{ε}}_{m} = {( \frac{1}{8.6249} \frac{σ - {σ}_{t h}}{{σ}_{b} - σ} )}^{1 / 0.3602} exp ( - 17 \; 128 / ( 8.314 T ) )$$

$${t}_{f} = {( \frac{1}{1.8529} \frac{σ - {σ}_{th}}{{σ}_{b} - σ} )}^{- 1 / 0.4244} exp ( 17128 / ( 8.314 T ) ) .$$

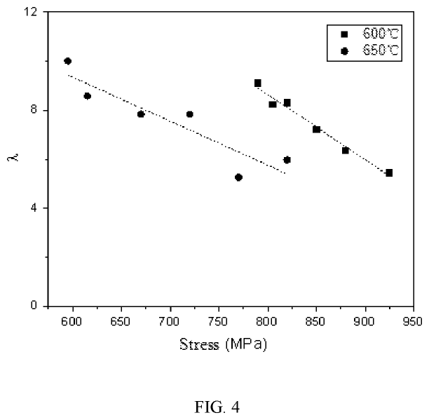

(6) Based on the prediction formula of the minimum creep rate \dot{ε}ₘ and creep life t_{ƒ}, the creep damage constitutive model is established:

$$\dot{ε} = {( \frac{1}{8.6249} \frac{σ - {σ}_{t h}}{{σ}_{b} - σ} )}^{1 / 0.3602} exp ( - 17 \; 128 / ( 8.314 T ) ) exp ( λ {ω}^{3 / 2} )$$

$$\dot{ω} = {( \frac{1 - {e}^{- q}}{q} ) [ {( \frac{1}{1.8529} \frac{σ - {σ}_{th}}{{σ}_{b} - σ} )}^{- 1 / 0.4244} exp ( 17128 / ( 8.314 T ) ) ]}^{- 1} exp ( q ω ) ,$$

where \dot{ε} is the strain rate, \dot{ω} is the damage rate, ε is the strain, ω is the damage, q is the constant related to temperature, λ is the constant related to temperature and stress. λ is defined as the logarithm of the ratio of creep rate to minimum creep rate at fracture, λ=1n((\dot{ε}_{final}/\dot{ε}ₘ). According to the high-temperature creep test data, the λ value corresponding to the high-temperature creep test is shown in FIG. 4:

The fitting formula λ=(α₁T+α₂)σ+(α₃T+α₄) is used to fit the λ test results, and α₁=1.76*10-4, α₂=−0.180, α₃=−0.198 and α₄=202.6 are obtained. Therefore, λ=(1.76*10⁻⁴ T−0.180)σ+(−0.198T+202.6) is obtained.

(7) Integrating the damage rate formula in step (6):

$$ω = - \frac{1}{q} ln [ 1 - ( 1 - {e}^{- q} ) \frac{t}{{t}_{f}} ] ,$$

where,

$${t}_{f} = {( \frac{1}{1.8529} \frac{σ - {σ}_{th}}{{σ}_{b} - σ} )}^{- 1 / 0.4244} exp ( 17128 / ( {8.3147}^{′} ) ) .$$

The above-mentioned damage ω obtained by integration is called analytical damage.

Mathematically transform the strain rate formula in step (6):

$$ω = {[ \frac{1}{λ} ln ( \dot{ε} / {\dot{ε}}_{m} ) ]}^{2 / 3} ,$$

where

$${\dot{ε}}_{m} = {( \frac{1}{8.6249} \frac{σ - {σ}_{th}}{{σ}_{b} - σ} )}^{1 / 0.3602} exp ( - 17128 / ( {8.3147}^{′} ) ) ,$$

the damage ω is called test damage.

At the same temperature, the numerical optimization algorithm is used to carry out a least square optimization on the analytical damage and the test damage, and the corresponding constant q value is obtained. The q value is 2.4652 at 600° C. and 3.4842 at 650° C. Then, by linearly fitting the temperature and the constant q value, the functional relationship between the constant q value and the temperature is established, and the constants b₁=0.0204 and b₂=−15.3265 in q=b₁T+b₂ are obtained. Then the expression of the constant q value is q=0.0204T-15.3265.

(8) After all the parameters in the damage constitutive model are determined through the above steps, the fourth-order Runge-Kutta method is used to solve the strain, and the evolution behavior of strain and deformation with time may be obtained. Specifically, the analytical damage ω obtained by integration is brought into the strain rate formula, and the creep rate \dot{ε}ₘ corresponding to at any time tₙ may be obtained. For the strain εₙ of at any time tₙ, the fourth-order Runge-Kutta algorithm may be used to calculate the strain increment of each adjacent time interval, and the strain εₙ may be solved by the method of accumulation:

$${ε}_{n} = {ε}_{0} + \frac{1}{6} {\sum }_{i = 1}^{n} \{ [ \dot{ε} ( {t}_{i - 1} ) + \dot{ε} ( {t}_{i} ) + 4 \dot{ε} ( \frac{{t}_{i - 1} + {t}_{i}}{2} ) ] * ( {t}_{i} - {t}_{i - 1} ) \} ,$$

where ε₀=0, t₀=0

For damage, the formula

$$ω = - \frac{1}{q} ln [ 1 - ( 1 - {e}^{- q} ) \frac{t}{{t}_{f}} ]$$

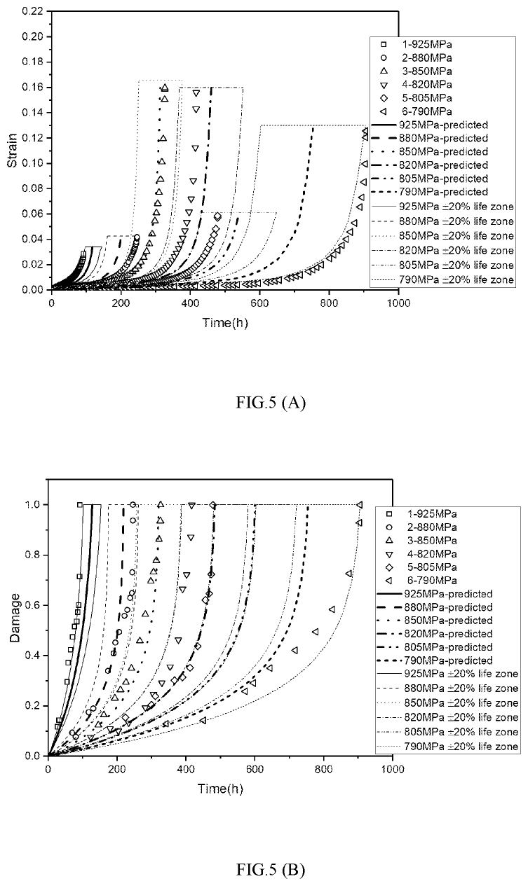

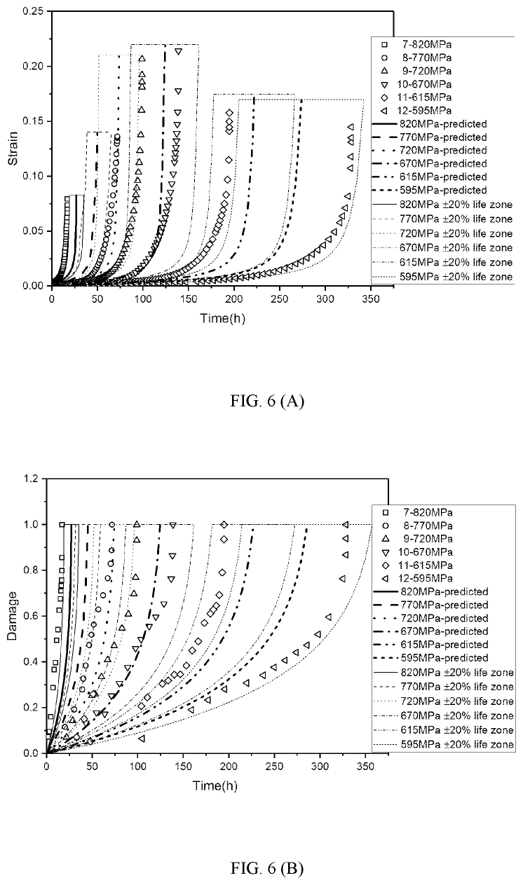

may be used to obtain the evolution behavior of damage with time. When t=t_{ƒ}, the creep fracture occurs, the damage ω=1. In this way, the creep damage and deformation evolution with time may be predicted. The evolution behaviors of creep strain and damage with time at 600° C. and 650° C. are shown in FIG. 5(A)-FIG. 5(B) and FIG. 6(A)-FIG. 6(B), respectively.

Therefore, the prediction of creep damage and deformation evolution with time under arbitrary temperature stress may be solved by the creep damage constitutive equation combined with the least square optimization algorithm and the fourth-order Runge-Kutta algorithm. The damage constitutive model formula is as follows:

$$\dot{ε} = {( \frac{1}{8.6249} \frac{σ - {σ}_{th}}{{σ}_{b} - σ} )}^{1 / 0.3602} exp ( - 17128 / ( {8.3147}^{′} ) ) exp ( {λω}^{3 / 2} )$$

$$\dot{ω} = {( \frac{1 - {e}^{- q}}{q} ) [ {( \frac{1}{1.8529} \frac{σ - {σ}_{th}}{{σ}_{b} - σ} )}^{- 1 / 0.4244} exp ( 17128 / ( {8.3147}^{′} ) ) ]}^{- 1} exp ( q ω ) ,$$

where λ=(1.76*10⁻⁴T−0.180)σ+(−0.198T+202.6), q=0.0204T−15.3265 σ_{b}=−3.7*T+4670.1, σₜₕ=−5.68*T+5551.64. To sum up, the stress-temperature correlations of all parameters in the model are clearly characterized, which makes the method applicable to any stress and temperature conditions and has strong extrapolation ability.

It may also be seen from FIG. 5(A)-FIG. 5(B) and FIG. 6(A)-FIG. 6(B) that this method models the average creep behavior under the same conditions, rather than a single creep curve. This method represents the median situation under this condition, and the predictions of creep damage and deformation almost all fall in the 20% life dispersion zone. The predicted results are in good agreement with the experimental results, showing satisfactory prediction accuracy, and reliable interpolation and extrapolation may be realized.

The above are only the preferred embodiments of the present application, and it should be pointed out that for those of ordinary skill in the technical field, without departing from the principle of the present application, several improvements and modifications may be made, and these improvements and modifications should fall in the protection scope of the present application.

What is claimed is:

1. A method for predicting creep damage and deformation evolution behaviors with time, comprising:
S1, carrying out high-temperature tensile tests of materials at different temperatures T to obtain tensile strength σ_{b} at different temperatures;
S2, carrying out high-temperature creep tests under different stress conditions at different temperatures to obtain corresponding creep strain curves, a minimum creep rate \dot{ε}ₘ and a creep life t_{ƒ};
S3, obtaining threshold stresses σₜₕ corresponding to different temperatures according to the minimum creep rate \dot{ε}ₘ obtained in the S2;
S4, establishing a functional relationship between the tensile strength σ_{b}, the threshold stress σₜₕ and the temperature T according to the tensile strength σ_{b} at different temperatures obtained in the S1 and the threshold stresses σₜₕ at different temperatures obtained in the S3;
S5, establishing prediction formulas of the minimum creep rate \dot{ε}ₘ and the creep life t_{ƒ} based on the threshold stress σₜₕ obtained in the S3 and the tensile strength σ_{b}, obtained in the S1 respectively, and predicting a minimum creep rate \dot{ε}ₘ and a creep life t_{ƒ} under any stress temperature conditions with the prediction formulas;
S6, establishing a creep damage constitutive model based on the prediction formulas of the minimum creep rate \dot{ε}ₘ and the creep life t_{ƒ} established in the S5, wherein the creep damage constitutive model comprises a strain rate formula and a damage rate formula;
S7, determining parameters in the creep damage constitutive model established in the S6; and
S8, obtaining an evolution behavior of strain deformation with time by solving the strain rate formula; and obtaining an evolution behavior of damage with time by solving the damage rate formula.

2. The method for predicting creep damage and deformation evolution behaviors with time according to claim 1, wherein in the S3, a relationship between the minimum creep rate \dot{ε}ₘ, the stress σ and the threshold stress σₜₕ at a same temperature is established by using the formula \dot{ε}ₘ=Aₘ(σ−σₜₕ)⁵ according to the minimum creep rate \dot{ε}ₘ data obtained from the high-temperature creep tests in the S2, Aₘ is a constant, a same operation for different temperatures is carried out, and then threshold stress levels corresponding to different temperatures are obtained.

3. The method for predicting creep damage and deformation evolution behaviors with time according to claim 1, wherein in the S4, a functional relationship between the tensile strength σ_{b}, the threshold stress σₜₕ and the temperature T is established according to the tensile strength σ_{b} at different temperatures obtained in the S1 and the threshold stresses σₜₕ at different temperatures obtained in the S3, and a polynomial is used for fitting,
$${σ}_{b} = {\sum }_{i = 0}^{n} {{a}_{i} ( T )}^{i} ,$$
$${σ}_{th} = {\sum }_{i = 0}^{n} {{b}_{i} ( T )}^{i}$$
with n as a number of polynomial terms, a₁, b₁ as fitting parameters, and i=0,1,2 . . . ,n, n≤3.

4. The method for predicting creep damage and deformation evolution behaviors with time according to claim 1, wherein in the S5, the prediction formulas of the minimum creep rate \dot{ε}ₘ and the creep life t_{ƒ} based on the threshold stress σₜₕ and the tensile strength σ_{b} are respectively established based on the threshold stress σₜₕ obtained in the S3 and the tensile strength σ_{b} obtained in the S1:
$${\dot{ε}}_{m} = {( \frac{1}{{A}_{1}} \frac{σ - {σ}_{th}}{{σ}_{b} - σ} )}^{1 / {n}_{1}} exp ( - {Q}_{N}^{*} / RT )$$
$${t}_{f} = {( \frac{1}{{A}_{2}} \frac{σ - {σ}_{th}}{{σ}_{b} - σ} )}^{1 / {n}_{2}} exp ( {Q}_{N}^{*} / RT ) ,$$
wherein A₁, A₂, n₁ and n₂ are constants, σₜₕ is the threshold stress, σ_{b} is the tensile strength, σ is applied stress, T is applied temperature, R is a gas constant, and Q*_{N} is apparent activation energy; and
the minimum creep rate \dot{ε}ₘ and creep life t_{ƒ} may be predicted with the above two expressions under arbitrary stress temperature conditions.

5. The method for predicting creep damage and deformation evolution behaviors with time according to claim 4, wherein in the S5, the apparent activation energy Q*_{N} is obtained in a following method: under a same
$$\frac{σ - {σ}_{th}}{{σ}_{b} - σ}$$
value, the apparent activation energy Q*_{N} is determined by a linear fitting straight line slope between a logarithm 1n \dot{ε}ₘ of the minimum creep rate and the reciprocal 1/T of the temperature.

6. The method for predicting creep damage and deformation evolution behaviors with time according to claim 4, wherein in the S6, a creep damage constitutive model is established based on the prediction formulas of the minimum creep rate \dot{ε}ₘ and the creep life t_{ƒ} in the S5:
$$\dot{ε} = {( \frac{1}{{A}_{1}} \frac{σ - {σ}_{th}}{{σ}_{b} - σ} )}^{1 / {n}_{1}} exp ( - {Q}_{N}^{*} / RT ) exp ( {λω}^{3 / 2} )$$
$$\dot{ω} = {( \frac{1 - {e}^{- q}}{q} ) [ {( \frac{1}{{A}_{2}} \frac{σ - {σ}_{th}}{{σ}_{b} - σ} )}^{- 1 / {n}_{2}} exp ( {Q}_{N}^{*} / RT ) ]}^{- 1} exp ( q ω ) ,$$
wherein \dot{ε} is the strain rate, \dot{ω} is the damage rate, ε is the strain and ω is the damage, q is a constant related to a temperature, λ is a constant related to the temperature and the stress; in order to ensure that when creep fracture occurs, the damage is 1, λ is defined as a logarithm of the creep rate \dot{ε}_{final} to the minimum creep rate \dot{ε}ₘ when creep fracture occurs, λ=1n(\dot{ε}_{final}/\dot{ε}ₘ); fitting the experimental data, and the expression of λ is established as λ=(α₁T+α₂)σ+(α₃T+α₄), and α₁, α₂, α₃ and α₄ are fitting parameters.

7. The method for predicting creep damage and deformation evolution behaviors with time according to claim 6, wherein in the S7, the damage rate formula in the S6 is integrated, obtaining:
$$ω = - \frac{1}{q} ln [ 1 - ( 1 - {e}^{- q} ) \frac{t}{{t}_{f}} ] ,$$
wherein
$${t}_{f} = {( \frac{1}{{A}_{2}} \frac{σ - {σ}_{th}}{{σ}_{b} - σ} )}^{1 / {n}_{2}} exp ( {Q}_{n}^{*} / RT ) ,$$
the damage ω obtained by an integral is called an analytical damage;
the strain rate formula is mathematically transformed in the S6 as follows:
$$ω = {[ \frac{1}{λ} ln ( \dot{ε} / {\dot{ε}}_{m} ) ]}^{2 / 3} , \\ {t}_{f} = {( \frac{1}{{A}_{1}} \frac{σ - {σ}_{th}}{{σ}_{b} - σ} )}^{1 / {n}_{1}} exp ( - {Q}_{n}^{*} / RT ) ,$$
a damage ω is called a test damage; and
a numerical optimization algorithm is used to carry out a least square optimization on the analytical damage and the test damage, and a corresponding constant q value is obtained.

8. The method for predicting creep damage and deformation evolution behavior with time according to claim 7, wherein in the S8, a fourth-order Runge-Kutta method is adopted to solve the strain rate formula to obtain an evolution behavior of strain and deformation with time; for the damage rate formula, a damage evolution behavior with time is obtained by using the formula
$$ω = - \frac{1}{q} ln [ 1 - ( 1 - {e}^{- q} ) \frac{t}{{t}_{f}} ] .$$
